(19) United States
(12) Patent Application Publication
(10) Pub. No.: US 2026/0140362 A1
(43) Pub. Date: May 21, 2026

(54) MOVABLE DEVICE

(71) Applicant: FUJIFILM Corporation, Tokyo (JP)

(72) Inventors: Yoshikazu HISHINUMA, Kanagawa (JP); Fumihiko MOCHIZUKI, Kanagawa (JP); Shuji TAKAHASHI, Kanagawa (JP); Takayuki NAONO, Kanagawa (JP); Keisuke AOSHIMA, Kanagawa (JP)

(73) Assignee: FUJIFILM Corporation, Tokyo (JP)

(21) Appl. No.: 19/449,713

(22) Filed: Jan. 15, 2026

Related U.S. Application Data
(63) Continuation of application No. PCT/JP2024/022995, filed on Jun. 25, 2024.

(30) Foreign Application Priority Data
Jul. 20, 2023 (JP) 2023-118687

(51) Int. Cl. G02B 26/08

(52) U.S. Cl. CPC G02B 26/0858

(57) ABSTRACT

A movable device according to the present disclosure includes a silicon structure including a torsion bar formed by processing a silicon substrate, and a wiring formed on the silicon structure, in which an amorphous alloy is included in a portion of the wiring formed on the torsion bar.

### CROSS-REFERENCE TO RELATED APPLICATIONS

This application is a continuation application of International Application No. PCT/JP2024/022995, filed Jun. 25, 2024, the disclosure of which is incorporated herein by reference in its entirety. Further, this application claims priority from Japanese Patent Application No. 2023-118687, filed on Jul. 20, 2023, the disclosure of which is incorporated herein by reference in its entirety.

### BACKGROUND

### 1. Technical Field

The technology of the present disclosure relates to a movable device.

### 2. Description of the Related Art

A micromirror device (also referred to as a microscanner) is known as one of micro electro mechanical systems (MEMS) devices manufactured using the silicon (Si) nanofabrication technique. Since the micromirror device is small and has low power consumption, it is expected to have a wide range of applications in laser displays, laser projectors, optical coherence tomography, and the like.

In general, the micromirror device includes a mirror portion, a torsion bar that swingably supports the mirror portion, and an actuator for allowing the mirror portion to swing.

The micromirror device is formed by processing a silicon substrate. Since the torsion bar formed by processing the silicon substrate has a property of being weak against a stress such as a torsional stress, it is known to form a torsion bar using an amorphous alloy having excellent mechanical characteristics (see, for example, JP2017-032627A).

### SUMMARY

However, in the micromirror device, a wiring may be formed on the torsion bar. Therefore, there is a problem that deterioration such as a crack and peeling may occur in a portion of the wiring on the torsion bar where a high stress is applied. Similar problems may occur in a movable device other than the micromirror device.

An object of the technology of the present disclosure is to provide a movable device capable of suppressing deterioration of a portion of a wiring formed on a torsion bar.

In order to achieve the above object, according to the present disclosure, there is provided a movable device comprising a silicon structure including a torsion bar formed by processing a silicon substrate, and a wiring formed on the silicon structure, in which an amorphous alloy is included in a portion of the wiring formed on the torsion bar.

In a case where an X-ray diffraction measurement is performed on the torsion bar, it is preferable that a peak value of a diffracted X-ray intensity corresponding to the amorphous alloy is equal to or less than 0.2 times a peak value of a diffracted X-ray intensity corresponding to the silicon structure.

It is preferable that the amorphous alloy includes Al and Ti.

In a case where a portion of the wiring that does not include the amorphous alloy is defined as a first wiring and a portion of the wiring that includes the amorphous alloy is defined as a second wiring, it is preferable that the second wiring is formed in a state where a part of the second wiring overlaps the first wiring.

It is preferable that the first wiring is an Au wiring.

It is preferable that the movable device includes a mirror portion, a driving unit that allows the mirror portion to swing by applying a rotational torque to the mirror portion, and a fixed frame that surrounds the mirror portion and the driving unit, and the torsion bar is connected between the fixed frame and the driving unit.

It is preferable that the wiring transmits a drive signal applied to the driving unit.

It is preferable that the silicon substrate is an SOI substrate.

According to the technology of the present disclosure, it is possible to provide a movable device capable of suppressing deterioration of a portion of a wiring formed on a torsion bar.

### BRIEF DESCRIPTION OF THE DRAWINGS

Exemplary embodiments according to the technique of the present disclosure will be described in detail based on the following figures, wherein:

FIG. 1 is a schematic view of an optical scanning device,

FIG. 2 is an external perspective view of a micromirror device,

FIG. 3 is a cross-sectional view of the micromirror device cut along a second axis,

FIG. 4 is a cross-sectional view showing a state where a mirror portion rotationally moves about a first axis,

FIG. 5 is a plan view showing an example of a layout of an electrode pad and a wiring provided in the micromirror device,

FIG. 6 is a diagram schematically showing a configuration example of a wiring that transmits a first drive signal,

FIG. 7 is a diagram schematically showing a step of forming the wiring,

FIG. 8 is a diagram showing a cross section of a second wiring in a case where an annealing temperature is lower than a certain temperature,

FIG. 9 is a diagram showing an electron diffraction image of the second wiring in a case where the annealing temperature is lower than the certain temperature,

FIG. 10 is a diagram showing a cross section of the second wiring in a case where the annealing temperature is equal to or higher than the certain temperature,

FIG. 11 is a diagram showing an electron diffraction image of the second wiring in a case where the annealing temperature is equal to or higher than the certain temperature,

FIG. 12 is a diagram showing a diffraction spectrum measured by an X-ray diffraction device, and

FIG. 13 is a diagram illustrating a definition of a peak value of a diffracted X-ray intensity.

### DETAILED DESCRIPTION

An example of an embodiment according to the technology of the present disclosure will be described with reference to the accompanying drawings.

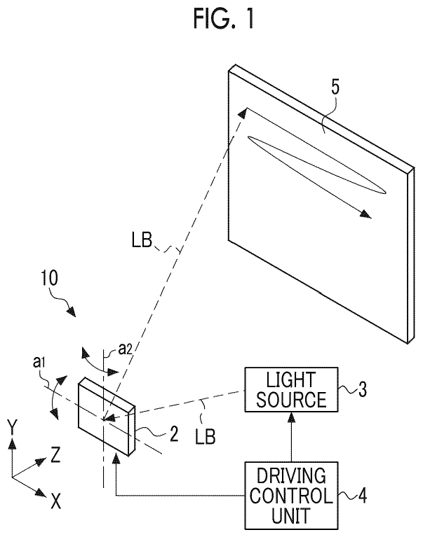

FIG. 1 schematically shows an optical scanning device 10 according to an embodiment. The optical scanning device 10 includes a micromirror device (hereinafter, referred to as MMD) 2, a light source 3, and a driving control unit 4. The optical scanning device 10 performs optical scanning on a surface to be scanned 5 by reflecting a light beam LB emitted from the light source 3 by the MMD 2 under the control of the driving control unit 4. The surface to be scanned 5 is a screen, a human retina, or the like. The MMD 2 is an example of a “movable device” according to the technology of the present disclosure.

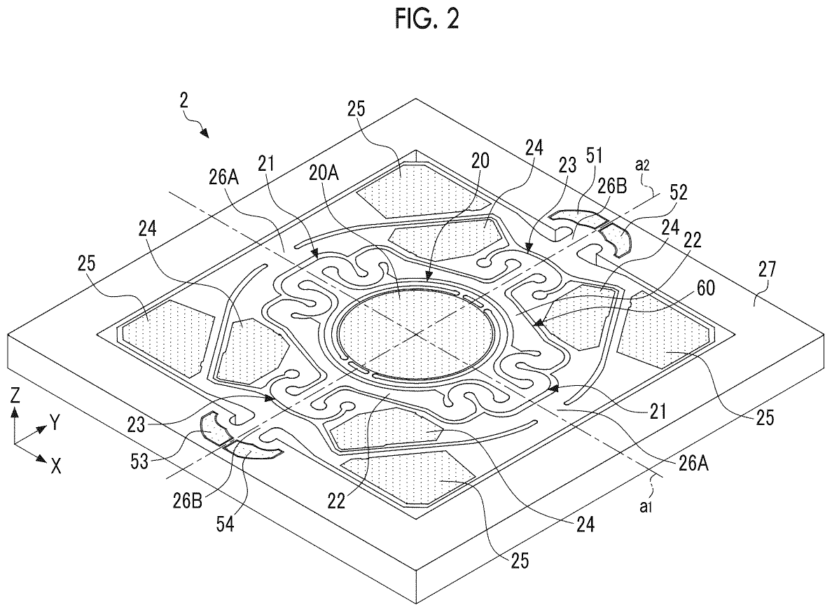

The MMD 2 is a piezoelectric biaxial drive type micromirror device capable of allowing a mirror portion 20 (see FIG. 2) to swing around a first axis a₁ and around a second axis a₂ intersecting with the first axis a₁. Hereinafter, the direction parallel to the first axis a₁ is referred to as an X direction, the direction parallel to the second axis a₂ is a Y direction, and the direction orthogonal to the first axis a₁ and the second axis a₂ is referred to as a Z direction. In the present embodiment, the X direction and the Y direction are orthogonal to each other.

The light source 3 is a laser device that emits, for example, laser light as the light beam LB. It is preferable that the light source 3 emits the light beam LB perpendicularly to a reflecting surface 20A (see FIG. 2) included in the mirror portion 20 in a state where the mirror portion 20 of the MMD 2 is stationary.

The driving control unit 4 outputs a drive signal to the light source 3 and the MMD 2 based on optical scanning information. The light source 3 generates the light beam LB based on the input drive signal and emits the light beam LB to the MMD 2. The MMD 2 allows the mirror portion 20 to swing around the first axis a₁ and the second axis a₂ based on the input drive signal.

The driving control unit 4 causes the mirror portion 20 to resonate about the first axis a₁ and the second axis a₂, so that the surface to be scanned 5 is scanned with the light beam LB reflected by the mirror portion 20 such that a Lissajous waveform is drawn. This optical scanning method is called a Lissajous scanning method.

The optical scanning device 10 is applied to, for example, a Lissajous scanning type laser display. Specifically, the optical scanning device 10 can be applied to a laser scanning display such as augmented reality (AR) glass or virtual reality (VR) glass.

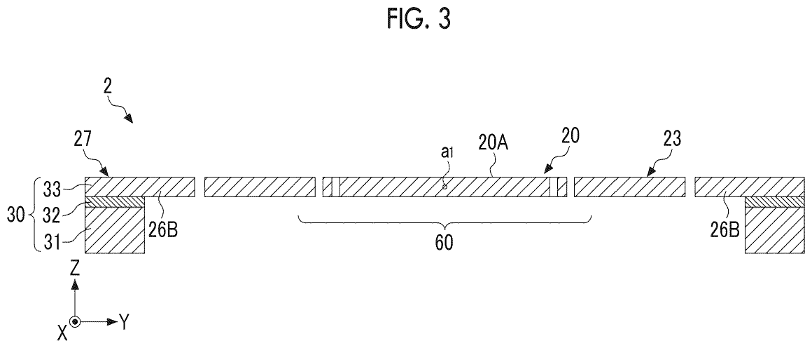

Next, a configuration of the MMD 2 will be described with reference to FIGS. 2 and 3. FIG. 2 is an external perspective view of the MMD 2. FIG. 3 is a cross-sectional view of the MMD 2 cut along the second axis a₂.

As shown in FIG. 2, the MMD 2 has the mirror portion 20, a pair of first support portions 21, a pair of movable frames 22, a pair of second support portions 23, a first actuator 24, a second actuators 25, a pair of first connecting portions 26A, a pair of second connecting portions 26B, and a fixed frame 27. The MMD 2 is a so-called MEMS scanner.

The mirror portion 20 has a reflecting surface 20A for reflecting incident light. The reflecting surface 20A is provided on one surface of the mirror portion 20, and is formed of a metal thin film such as gold (Au) and aluminum (Al). The shape of the reflecting surface 20A is, for example, circular with the intersection of the first axis a₁ and the second axis a₂ as the center.

The first axis a₁ and the second axis a₂ exist, for example, in a plane including the reflecting surface 20A in a case where the mirror portion 20 is stationary. The planar shape of the MMD 2 is rectangular, line-symmetrical about the first axis a₁, and line-symmetrical about the second axis a₂.

The pair of first support portions 21 are disposed at positions facing each other across the second axis a₂, and have a shape that is line-symmetrical about the second axis a₂. In addition, each of the first support portions 21 has a shape that is line-symmetrical about the first axis a₁. Each of the first support portions 21 is connected to the mirror portion 20 on the first axis a₁, and swingably supports, around the first axis a_{1,} the mirror portion 20.

The pair of movable frames 22 are disposed at positions facing each other across the first axis a₁, and have a shape that is line-symmetrical about the first axis a₁. Each of the movable frames 22 has a shape that is line-symmetrical about the second axis a₂. In addition, each of the movable frames 22 is curved along an outer periphery of the mirror portion 20. Both ends of each of the movable frames 22 are connected to the pair of first support portions 21.

The pair of first support portions 21 and the pair of movable frames 22 are connected to each other to surround the mirror portion 20. The mirror portion 20, the pair of first support portions 21, and the pair of movable frames 22 constitute a movable portion 60.

The pair of second support portions 23 are disposed at positions facing each other across the first axis a₁, and have a shape that is line-symmetrical about the first axis a₁. Each of the second support portions 23 has a shape that is line-symmetrical about the second axis a₂. Each of the second support portions 23 is connected to the movable frame 22 on the second axis a₂, and swingably supports, around the second axis a₂, the movable portion 60 having the mirror portion 20. In addition, both ends of each of the second support portions 23 are connected to the first actuator 24.

The first actuator 24 is composed of a pair of piezoelectric actuators facing each other across the second axis a₂, and has a shape that is line-symmetric about the second axis a₂. In addition, each of the first actuators 24 has a shape that is line-symmetric about the first axis a₁. The first actuator 24 is disposed along an outer periphery of the pair of movable frames 22 and the pair of first support portions 21.

In FIG. 2, the piezoelectric actuators constituting the first actuator 24 appear to be separated across the first axis a₁, but the two piezoelectric actuators facing each other across the first axis a₁ are electrically connected to each other by wirings (not shown).

The pair of second support portions 23 and the first actuator 24 are connected to each other to surround the movable portion 60.

The second actuator 25 is composed of a pair of piezoelectric actuators facing each other across the first axis a₁, and has a shape that is line-symmetric about the first axis a₁. In addition, the second actuators 25 have a shape that is line-symmetrical about the second axis a₂. The second actuator 25 is disposed along an outer periphery of the first actuator 24 and the pair of second support portions 23.

In FIG. 2, the piezoelectric actuators constituting the second actuator 25 appear to be separated near the second axis a₂, but the two piezoelectric actuators facing each other across the second axis a₂ are electrically connected to each other by wirings (not shown).

The pair of first connecting portions 26A are disposed at positions facing each other across the second axis a₂, and have a shape that is line-symmetrical about the second axis a₂. In addition, each of the first connecting portions 26A has a shape that is line-symmetrical about the first axis a₁. Each of the first connecting portion 26A is disposed along the first axis a₁, and connects the first actuator 24 and the second actuator 25 on the first axis a₁. Each of the first connecting portions 26A is an example of a “torsion bar” according to the technology of the present disclosure.

The pair of second connecting portions 26B are disposed at positions facing each other across the first axis a₁, and have a shape that is line-symmetrical about the first axis a₁. In addition, each of the second connecting portions 26B is stretched in the Y direction, and has a shape that is line-symmetrical about the second axis a₂. Each of the second connecting portion 26B is disposed along the second axis a₂, and connects the second actuator 25 and the fixed frame 27 on the second axis a₂. Each of the second connecting portions 26B is an example of a “torsion bar” according to the technology of the present disclosure.

The second actuator 25 and the pair of second connecting portion 26B are connected to each other to surround a pair of movable portions 60 and the first actuator 24. The first actuator 24 and the second actuator 25 constitute a driving unit surrounding the pair of movable frames 22. That is, the driving unit includes a plurality of piezoelectric actuators facing each other across the first axis a₁ or the second axis a₂.

The fixed frame 27 is a frame-shaped member having a rectangular outer shape, and has a shape that is line-symmetrical about each of the first axis a₁ and the second axis a₂. The fixed frame 27 surrounds an outer periphery of the second actuator 25 and the pair of second connecting portions 26B. That is, the fixed frame 27 surrounds the driving unit. The pair of second connecting portions 26B are connected between the fixed frame 27 and the driving unit.

The first actuator 24 allows the movable portion 60 to swing around the second axis a₂ by applying the rotational torque around the second axis a₂ to the mirror portion 20 and the pair of movable frames 22. The second actuator 25 allows the mirror portion 20 to swing around the first axis a₁ by applying the rotational torque around the first axis a₁ to the mirror portion 20, the pair of movable frames 22, and the first actuator 24.

Four piezoelectric sensors 51 to 54 are provided in the vicinity of the pair of second connecting portions 26B as an angle sensor for detecting an angle of the mirror portion 20. The piezoelectric sensors 51 to 54, similarly to the first actuator 24 and the second actuator 25, are formed of a piezoelectric element. The piezoelectric sensors 51 to 54 are in a line-symmetrical relationship about the first axis a₁ and the second axis a₂. Specifically, the piezoelectric sensors 51 and 52 are disposed in the vicinity of one of the pair of second connecting portions 26B, and have a line-symmetrical relationship in position and shape about the second axis a₂. The piezoelectric sensors 53 and 54 are disposed in the vicinity of the other of the pair of second connecting portions 26B, and have a line-symmetrical relationship in position and shape about the second axis a₂.

In FIG. 2, wirings and electrode pads for transmitting the drive signal to the first actuator 24 and the second actuator 25 are not shown. In addition, wiring and electrode pads for acquiring a voltage signal output from the piezoelectric sensors 51 to 54 are not shown. A plurality of the electrode pads are provided on the fixed frame 27.

As shown in FIG. 3, the MMD 2 is formed, for example, by performing an etching treatment on a silicon on insulator (SOI) substrate 30. The SOI substrate 30 is a substrate in which a silicon oxide layer 32 is provided on a silicon support layer 31 made of single crystal silicon, and a silicon active layer 33 made of single crystal silicon is provided on the silicon oxide layer 32. The SOI substrate 30 is an example of a “silicon substrate” according to the technology of the present disclosure.

The mirror portion 20, the pair of first support portions 21, the pair of movable frames 22, the pair of second support portion 23, the first actuator 24, the second actuator 25, the pair of first connecting portions 26A, and the pair of second connecting portions 26B are formed of the silicon active layer 33 remaining by removing the silicon support layer 31 and the silicon oxide layer 32 from the SOI substrate 30 by an etching treatment. The silicon active layer 33 functions as an elastic portion having elasticity. The silicon active layer 33 is an example of a “silicon structure including a torsion bar formed by processing a silicon substrate” according to the technology of the present disclosure.

The fixed frame 27 is formed of three layers of the silicon support layer 31, the silicon oxide layer 32, and the silicon active layer 33. That is, the mirror portion 20, the pair of first support portions 21, the pair of movable frames 22, the pair of second support portions 23, the first actuator 24, the second actuator 25, the pair of first connecting portions 26A, and the pair of second connecting portions 26B have a smaller thickness than the fixed frame 27.

The piezoelectric actuator constituting the first actuator 24 is composed of a piezoelectric element formed on the silicon active layer 33. The piezoelectric element has a laminated structure in which a lower electrode, a piezoelectric film, and an upper electrode are sequentially laminated on the second silicon active layer 33. The second actuator 25 has the same configuration as the first actuator 24.

The lower electrode and the upper electrode are formed of, for example, metal such as gold (Au) or platinum (Pt). The piezoelectric film is formed of, for example, lead zirconate titanate (PZT), which is a piezoelectric material. The lower electrode and the upper electrode are electrically connected to the driving control unit 4 described above via the wiring and the electrode pad.

The lower electrode is connected to the driving control unit 4 via the wiring and the electrode pad, and a ground potential is applied thereto. A driving voltage is applied to the upper electrode from the driving control unit 4.

In a case where a positive or negative voltage is applied to the piezoelectric film in the polarization direction, deformation (for example, expansion and contraction) proportional to the applied voltage occurs. That is, the piezoelectric film exerts a so-called inverse piezoelectric effect. The piezoelectric film exerts an inverse piezoelectric effect by applying a driving voltage from the driving control unit 4 to the upper electrode, and displaces the first actuator 24 and the second actuator 25.

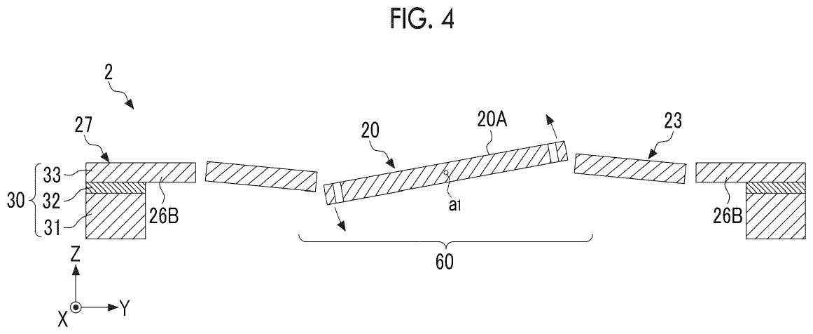

FIG. 4 shows an example in which one of the pair of piezoelectric actuators constituting the second actuator 25 is extended and the other of the pair of piezoelectric actuators is contracted, thereby generating the rotational torque around the first axis a₁ in the second actuator 25. In this way, one and the other of the pair of piezoelectric actuators are displaced in opposite directions to each other, whereby the mirror portion 20 rotationally moves about the first axis a₁. Similarly, one and the other of the pair of piezoelectric actuator actuators constituting the first actuator 24 are displaced in opposite directions to each other, whereby the mirror portion 20 rotationally moves about the second axis a₂. In this way, in a case where the mirror portion 20 is rotationally moved, a high stress is applied to portions such as the pair of first connecting portions 26A and the pair of second connecting portions 26B.

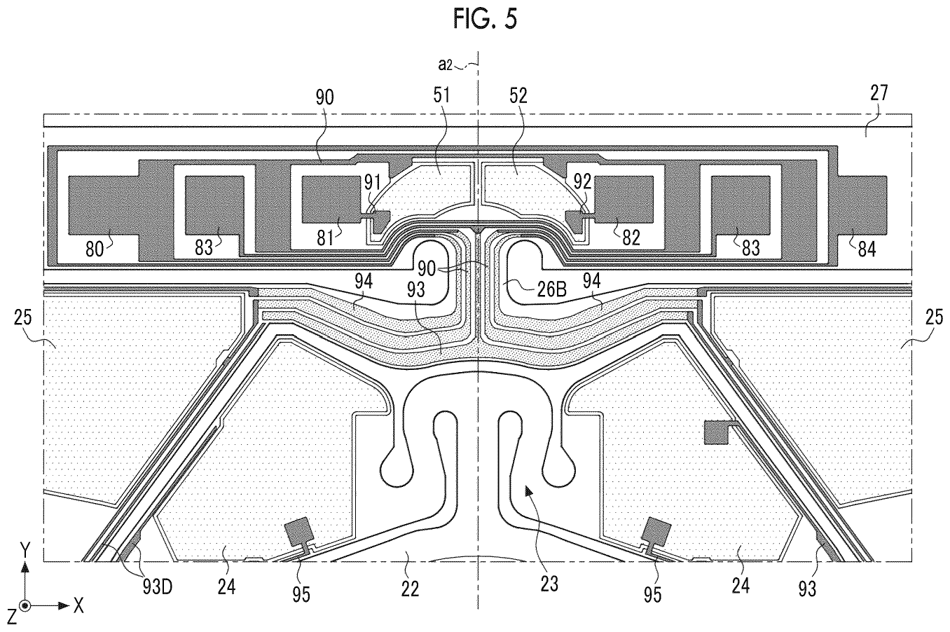

FIG. 5 shows an example of a layout of an electrode pad and a wiring provided in the MMD 2. FIG. 5 is a partially enlarged view of a region including one second connecting portion 26B.

A plurality of electrode pads 80 to 84 are formed on the fixed frame 27. The electrode pad 80 is an electrode pad for applying a ground potential, and is connected to a wiring 90. The wiring 90 is connected to the lower electrode of the piezoelectric actuator constituting the first actuator 24 and the second actuator 25 and the lower electrode of the piezoelectric sensors 51 to 54.

The electrode pad 81 is an electrode pad for acquiring a voltage signal from the piezoelectric sensor 51, and is connected to a wiring 91 described above. Similarly, the electrode pad 82 is an electrode pad for acquiring a voltage signal from the piezoelectric sensor 52, and is connected to a wiring 92.

The electrode pad 83 is an electrode pad for applying a second drive signal to the first actuator 24, and is connected to a wiring 93. The wiring 93 is connected to the upper electrode of the piezoelectric actuator constituting the first actuator 24. Although a pair of electrode pads 83 are provided at positions facing each other across the second axis a₂ on the fixed frame 27, both are electrically connected to each other via the wiring 93.

The electrode pad 84 is an electrode pad for applying the first drive signal to the second actuator 25, and is connected to a wiring 94. The wiring 94 is connected to the upper electrode of the piezoelectric actuator constituting the second actuator 25.

The wirings 90, 93, and 94 are routed from above the fixed frame 27, over the second connecting portion 26B, to a formation region of the second actuator 25. In addition, although not shown in FIG. 5, the wirings 90 and 93 are further routed from the second actuator 25, over the first connecting portion 26A, to the formation region of the first actuator 24. That is, the wirings 90, 93, and 94 are examples of a “wiring formed on a silicon structure” according to the technology of the present disclosure.

In addition, wirings 95 and 93D are formed in the MMD 2. The wiring 95 is provided in each of the first actuators 24 and connects upper electrodes of two piezoelectric actuators facing each other across the second axis a₂ to each other. The wiring 93D is a dummy wiring formed at a position that is line-symmetric to the wiring 93 about the second axis a₂, and is electrically isolated.

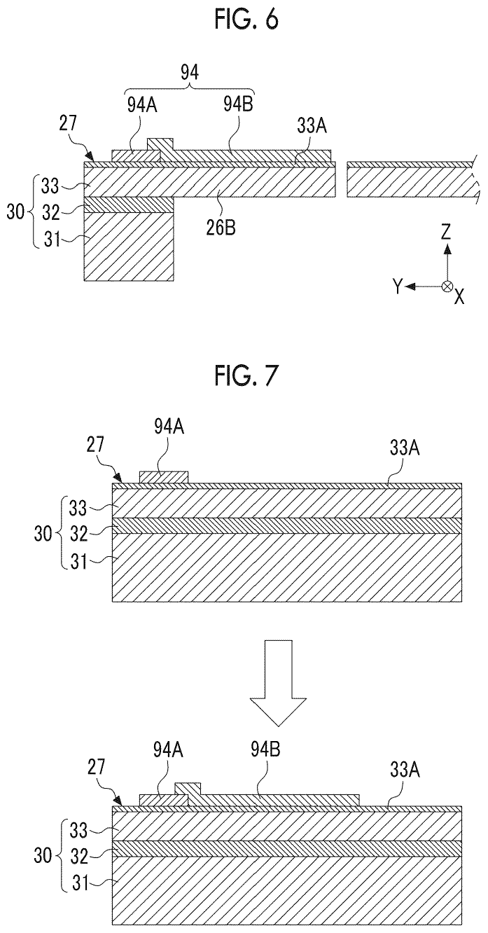

FIG. 6 schematically shows a configuration example of the wiring 94 that transmits the first drive signal. The wiring 94 is formed on the silicon active layer 33. Specifically, a surface of the silicon active layer 33 is covered with a thermal oxide film 33A made of silicon dioxide (SiO₂) formed in a thermal oxidation step, and the wiring 94 is formed on the thermal oxide film 33A.

The wiring 94 includes a first wiring 94A and a second wiring 94B. One end of the first wiring 94A is connected to the electrode pad 84, and the other end is connected to the second wiring 94B. The first wiring 94A is mainly provided in a region (fixed frame 27 or the like) in which a stress applied when the mirror portion 20 swings is small. The second wiring 94B is provided in a region (surface of the first connecting portion 26A, the second connecting portion 26B, or the like) in which a stress applied when the mirror portion 20 swings is large.

For example, the first wiring 94A is an Au wiring formed of gold (Au). The second wiring 94B is made of an amorphous alloy. That is, the wiring 94 includes the amorphous alloy in a portion formed on the first connecting portion 26A (that is, the torsion bar). In the wiring 94, a portion that does not include the amorphous alloy is the first wiring 94A, and a portion that includes the amorphous alloy is the second wiring 94B.

The amorphous alloy refers to an alloy that does not have a regular arrangement of atoms over a range of several atoms or more and does not have a crystal structure. In the present embodiment, the second wiring 94B is an amorphous alloy including aluminum (Al) and titanium (Ti). A compositional ratio of Al and Ti included in the amorphous alloy is, for example, 75%: 25% in terms of an atomic ratio. A barrier metal layer consisting of titanium (Ti) or the like is integrally formed at each bottom portion of the first wiring 94A and the second wiring 94B.

The first wiring 94A has more excellent conductivity than the second wiring 94B. On the other hand, the second wiring 94B has more excellent mechanical characteristics than the first wiring 94A. Therefore, in the present embodiment, in the wiring 94, a portion on the torsion bar where a high stress is applied is defined as the second wiring 94B, and the other portions are defined as the first wiring 94A. As a result, the wiring 94 suppresses deterioration (for example, occurrence of a crack and peeling) of a portion on the torsion bar due to the stress, and has excellent conductivity.

The wirings 90 and 93 are configured by connecting the first wiring such as the Au wiring and the second wiring made of the amorphous alloy, similarly to the wiring 94. In addition, in the wirings 90 and 93, a portion on the torsion bar where a high stress is applied is the second wiring. As a result, the wirings 90 and 93 suppress deterioration (for example, occurrence of a crack and peeling) of a portion on the torsion bar due to the stress, and have excellent conductivity.

FIG. 7 schematically shows a step of forming the wiring 94. First, an Au film is deposited on a surface of the silicon active layer 33 of the SOI substrate 30, and the deposited Au film is patterned to form the first wiring 94A. The Au film is deposited after a barrier metal is deposited.

Then, after the first wiring 94A is formed, an amorphous alloy film is deposited, and the deposited amorphous alloy film is patterned to form the second wiring 94B. The amorphous alloy film is deposited after the barrier metal is deposited.

The first wiring and the second wiring constituting the wirings 90 and 93 are formed at the same time as the first wiring 94A and the second wiring 94B constituting the wiring 94.

In the SOI substrate 30, the etching treatment is performed after all the structures such as the wiring, the electrode pad, the piezoelectric actuator, and the piezoelectric sensor are formed on the silicon active layer 33.

As described above, since the second wiring 94B is formed after the first wiring 94A is formed, the second wiring 94B is formed in a state where a part of the second wiring 94B overlaps the first wiring 94A.

The second wiring 94B made of an amorphous alloy has a surface that is oxidized over time and therefore has a high resistance. Meanwhile, the first wiring 94A made of Au wiring has a surface that is not oxidized and therefore maintains a low resistance. As described above, by forming the second wiring 94B in a state where a part of the second wiring 94B overlaps the first wiring 94A, a contact resistance between the first wiring 94A and the second wiring 94B is reduced, and the conductivity of the wiring 94 is improved. The same effect can be obtained for the wirings 90 and 93 that are formed at the same time as the wiring 94.

The MMD 2 is used in a state of being hermetically sealed into a package (not shown). The package is provided with an opening portion, and a cover glass for transmitting the light beam LB is attached to the opening portion. In a post step of sealing the MMD 2 into the package, an annealing treatment is performed. The amorphous alloy has excellent mechanical characteristics. However, crystallization may occur when a high temperature is applied during the annealing treatment, and the mechanical characteristics may be deteriorated due to the crystallization. As described above, the present applicant has found that, even in a case where the wirings 90, 93, and 94 are formed, in a case where a temperature during the annealing treatment in the post step (hereinafter, referred to as an annealing temperature) is high, deterioration (for example, crack, peeling, or the like) may occur in the second wiring made of the amorphous alloy. Therefore, by setting the annealing temperature to be lower than a certain temperature, the second wiring can be maintained in an amorphous state, and the deterioration of the second wiring can be suppressed.

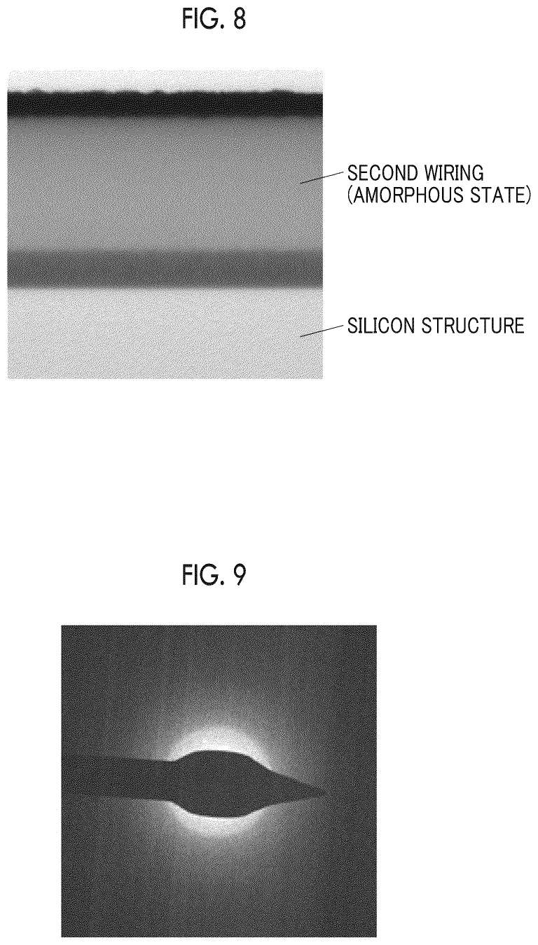

FIG. 8 shows a cross section of the second wiring in a case where the annealing temperature is lower than the certain temperature. FIG. 9 shows an electron diffraction image of the second wiring in a case where the annealing temperature is lower than the certain temperature. In a case where the annealing temperature is lower than the certain temperature, the second wiring is maintained in an amorphous state. According to FIG. 9, it can be seen that there is no diffraction point in the electron diffraction image, and the crystallization has not occurred.

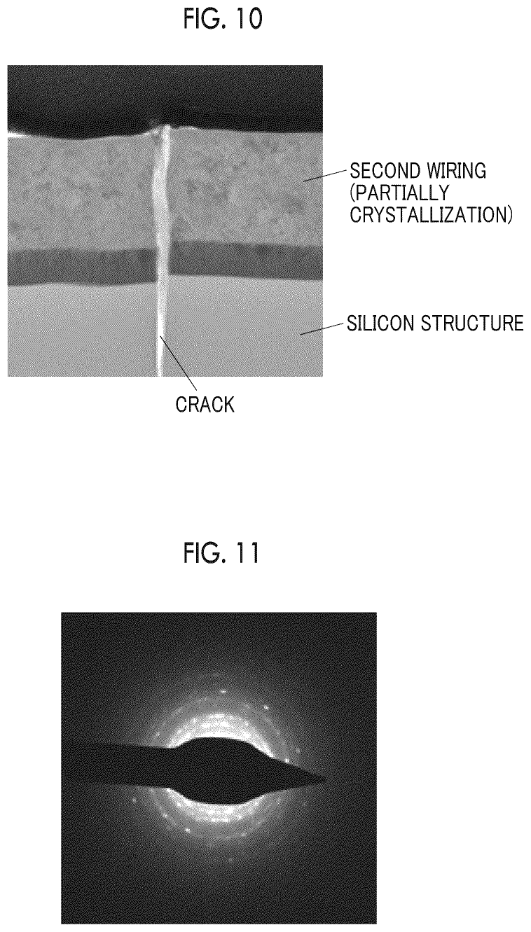

FIG. 10 shows a cross section of the second wiring in a case where the annealing temperature is equal to or higher than the certain temperature. FIG. 11 shows an electron diffraction image of the second wiring in a case where the annealing temperature is equal to or higher than the certain temperature. In a case where the annealing temperature is equal to or higher than the certain temperature, the second wiring is crystallized. According to FIG. 11, it can be seen that there is a diffraction point in the electron diffraction image, and the crystallization has occurred.

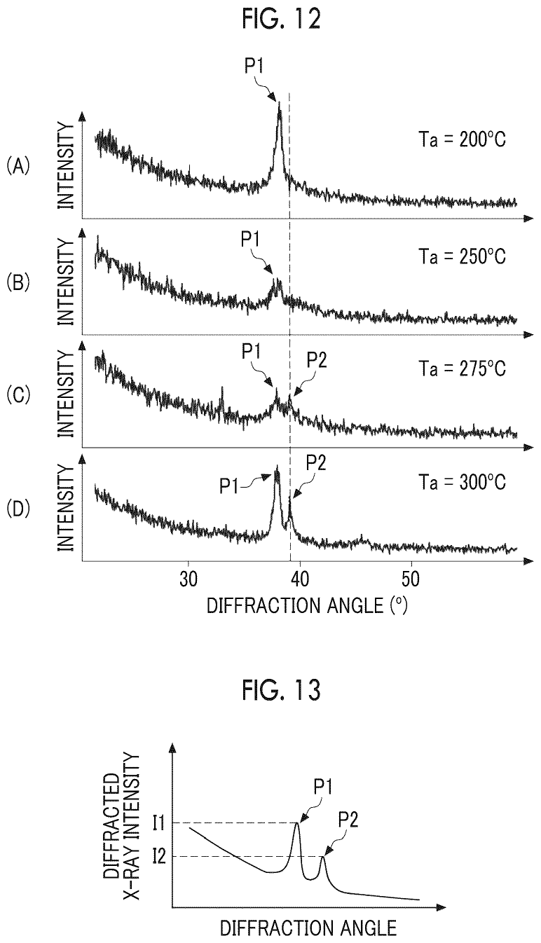

FIG. 12 shows a diffraction spectrum obtained by performing an X-ray diffraction measurement on the torsion bar. In FIG. 12, a vertical axis represents a diffracted X-ray intensity, and a horizontal axis represents a diffraction angle. The present applicant has created a plurality of samples of the MMD 2, performed the annealing treatment on each sample at different annealing temperatures Ta, and measured the diffraction spectrum. (A) of FIG. 12 shows a diffraction spectrum in a case where Ta=200° C. (B) of FIG. 12 shows a diffraction spectrum in a case where Ta=250° C. (C) of FIG. 12 shows a diffraction spectrum in a case where Ta=275° C. (D) of FIG. 12 shows a diffraction spectrum in a case where Ta=300° C. In any case, the annealing time is 10 minutes.

In (A) to (D) of FIG. 12, P1 represents a peak of a diffracted X-ray intensity corresponding to the silicon structure (in the above-described embodiment, the silicon active layer 33) present below the second wiring. P2 represents a peak of a diffracted X-ray intensity corresponding to the amorphous alloy included in the second wiring (for example, the second wiring 94B in the above-described embodiment). Specifically, the peak P1 represents an intensity of X-rays diffracted by a silicon crystal constituting the silicon structure. The peak P2 represents an intensity of X-rays diffracted by crystallization of the amorphous alloy included in the second wiring.

As shown in (A) to (D) of FIG. 12, in a case where the annealing temperature Ta is high, the peak P2 appears in the diffraction spectrum. This is because the amorphous alloy is partially crystallized by the annealing treatment. In a case where the second wiring is crystallized, the deterioration (for example, crack, peeling, or the like) occurs due to the stress. The present applicant has confirmed that, in the post step, the crystallization of the amorphous alloy is suppressed by setting the annealing temperature Ta to be lower than 260° C., and the deterioration due to the stress is suppressed. That is, in a case where Ta <260° C., the peak P2 hardly appears in the diffraction spectrum.

As shown in FIG. 13, a peak value of the diffracted X-ray intensity corresponding to the silicon structure is denoted by I1, and a peak value of the diffracted X-ray intensity corresponding to the amorphous alloy included in the second wiring is denoted by I2. In order to suppress the deterioration of the second wiring due to the stress, it is preferable that the peak value I2 is equal to or less than 0.2 times the peak value I1 (that is, I2≤0.2 ×I1) after the annealing treatment.

The configuration of the MMD 2 according to the above-described embodiment is an example, and various modifications are possible. In addition, the technology of the present disclosure is not limited to the MMD, and can be applied to other movable devices formed by the MEMS technology.

The following technology can be understood based on the above description.

### Appendix 1

A movable device comprising:
a silicon structure including a torsion bar formed by processing a silicon substrate; and
a wiring formed on the silicon structure,
in which an amorphous alloy is included in a portion of the wiring formed on the torsion bar.

### Appendix 2

The movable device according to Appendix 1,
in which, in a case where an X-ray diffraction measurement is performed on the torsion bar, a peak value of a diffracted X-ray intensity corresponding to the amorphous alloy is equal to or less than 0.2 times a peak value of a diffracted X-ray intensity corresponding to the silicon structure.

### Appendix 3

The movable device according to Appendix 1 or 2,
in which the amorphous alloy includes Al and Ti.

### Appendix 4

The movable device according to any one of Appendices 1 to 3,
in which, in a case where a portion of the wiring that does not include the amorphous alloy is defined as a first wiring and a portion of the wiring that includes the amorphous alloy is defined as a second wiring, the second wiring is formed in a state where a part of the second wiring overlaps the first wiring.

### Appendix 5

The movable device according to Appendix 4,
in which the first wiring is an Au wiring.

### Appendix 6

The movable device according to any one of Appendices 1 to 5, further comprising:
a mirror portion;
a driving unit that allows the mirror portion to swing by applying a rotational torque to the mirror portion; and
a fixed frame that surrounds the mirror portion and the driving unit,
in which the torsion bar is connected between the fixed frame and the driving unit.

### Appendix 7

The movable device according to Appendix 6,
in which the wiring transmits a drive signal applied to the driving unit.

### Appendix 8

The movable device according to any one of Appendices 1 to 7,
in which the silicon substrate is an SOI substrate.

What is claimed is:

1. A movable device comprising:
a silicon structure including a torsion bar formed by processing a silicon substrate; and
a wiring formed on the silicon structure,
wherein an amorphous alloy is included in a portion of the wiring formed on the torsion bar.

2. The movable device according to claim 1,
wherein, in a case where an X-ray diffraction measurement is performed on the torsion bar, a peak value of a diffracted X-ray intensity corresponding to the amorphous alloy is equal to or less than 0.2 times a peak value of a diffracted X-ray intensity corresponding to the silicon structure.

3. The movable device according to claim 1,
wherein the amorphous alloy includes Al and Ti.

4. The movable device according to claim 1,
wherein, in a case where a portion of the wiring that does not include the amorphous alloy is defined as a first wiring and a portion of the wiring that includes the amorphous alloy is defined as a second wiring, the second wiring is formed in a state where a part of the second wiring overlaps the first wiring.

5. The movable device according to claim 4,
wherein the first wiring is an Au wiring.

6. The movable device according to claim 1, further comprising:
a mirror portion;
a driving unit that allows the mirror portion to swing by applying a rotational torque to the mirror portion; and
a fixed frame that surrounds the mirror portion and the driving unit, wherein the torsion bar is connected between the fixed frame and the driving unit.

7. The movable device according to claim 6,
wherein the wiring transmits a drive signal applied to the driving unit.

8. The movable device according to claim 1,
wherein the silicon substrate is an SOI substrate.
